(19) United States
(12) Patent Application Publication
(10) Pub. No.: US 2025/0219778 A1
(43) Pub. Date: Jul. 3, 2025

(54) UPLINK AND DOWNLINK SOUNDING TO PASSIVE BACKSCATTER DEVICES

(71) Applicant: Cisco Technology, Inc., San Jose, CA (US)

(72) Inventors: Matthew Aaron Silverman, Shaker Heights, OH (US); Ardalan Alizadeh, Milpitas, CA (US); Peiman Amini, Fremont, CA (US); Indermeet S. Gandhi, San Jose, CA (US); Sivadeep Reddy Kalavakuru, Akron, OH (US); Robert E. Barton, Richmond (CA)

(21) Appl. No.: 18/927,090

(22) Filed: Oct. 25, 2024

Related U.S. Application Data
(60) Provisional application No. 63/615,383, filed on Dec. 28, 2023.

(51) Int. Cl. H04L 5/00; H04B 7/22; H04L 25/02

(52) U.S. Cl. CPC H04L 5/0048; H04L 25/0224; H04B 7/22

(57) ABSTRACT

Coordinated sounding of passive devices and, specifically, uplink and downlink sounding to Ambient Power (AMP) Backscatter Devices (BKDs) may be provided. Channel sounding with BKDs can include sending a sounding announcement frame to a BKD a receiving device, wherein the sounding announcement frame announces a plurality of sounding frames for channel sounding over a plurality of antenna states of the BKD. A first sounding frame is sent to the BKD and the receiving device, wherein the BKD is set to a first state of the plurality of antenna states. Then, a second sounding frame is sent to the BKD and the receiving device, wherein the BKD is set to a second state of the plurality of antenna states. Channel sounding feedback is received from the receiving device.

### RELATED APPLICATION

Under provisions of 35 U.S.C. § 119(e), Applicant claims the benefit of and priority to U.S. Provisional Application No. 63/615,383, filed Dec. 28, 2023, the disclosure of which is incorporated herein by reference in its entirety.

### TECHNICAL FIELD

The present disclosure relates generally to providing coordinated sounding of passive devices and specifically to providing uplink and downlink sounding to passive Backscatter Devices (BKDs).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for passive Backscatter Device (BKD) sounding in accordance with aspects of the present disclosure.

FIG. 2 is a block diagram of a Null Data Packet Announcement-BKD (NDPA-BKD) frame in accordance with aspects of the present disclosure.

FIG. 3 is a signal diagram of a signal process for passive BKD sounding in accordance with aspects of the present disclosure.

FIG. 4 is a flow chart of a method for passive BKD sounding in accordance with aspects of the present disclosure.

FIG. 5 is a block diagram of a computing device in accordance with aspects of the present disclosure.

FIG. 6 is a block diagram of a communications device in accordance with aspects of the present disclosure.

### DETAILED DESCRIPTION

### Overview

Coordinated sounding of passive devices and, specifically, uplink and downlink sounding to Ambient Power (AMP) Backscatter Devices (BKDs) may be provided. Channel sounding with BKDs can include sending a sounding announcement frame to a BKD a receiving device, wherein the sounding announcement frame announces a plurality of sounding frames for channel sounding over a plurality of antenna states of the BKD. A first sounding frame is sent to the BKD and the receiving device, wherein the BKD is set to a first state of the plurality of antenna states. Then, a second sounding frame is sent to the BKD and the receiving device, wherein the BKD is set to a second state of the plurality of antenna states. Channel sounding feedback is received from the receiving device.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Backscatter Devices (BKDs) are devices that can receive a wireless signal, modulate the signal, and reflect the modulated signal to a destination. Modulating the signal can comprise amplitude shift keying, such as on-off keying. Amplitude shift keying includes representing data in the form of variations in the amplitude of the received signal.

BKDs may be limited in power and processing capabilities, however. For example, BKDs can have an external battery, have a limited power supply, or be passive devices. Ambient Power (AMP) BKDs and other passive BKDs can use Radio Frequency (RF) signals to transmit data without a power source such as a battery or a connection to electricity. In some embodiments, AMP BKDs can use RF signals to charge a power source.

BKDs may use an antenna to receive a RF signal, use the RF signal for excitation (e.g., convert the RF signal into electricity), and/or modulate or otherwise modify and reflect the RF signal with encoded data. Other devices can receive a reflected RF signal transmitted by a BKD to determine the data the BKD is sending. BKD operations may be described in documents and standards from the Institute of Electrical and Electronics Engineers (IEEE). For example, the IEEE AMP topic interest group and the IEEE 802.11 standard may describe the operations of BKDs.

Fully passive BKDs such as RF Identification (RFID) tags usually have different banks of memory. In normal operation, an RFID reader (e.g., a scanner) may be used to excite the RFID tag, and the RFID tag may respond with a pre-configured message that includes the information stored on one or more of the tag's memory banks. BKDs can also include sensors, and the BKDs can store sensor data on a memory bank and transmit the sensor data when the BKD receives an excitation signal, for example from a scanner.

Channel sounding is a technique for evaluating an environment for wireless communication. Sounding can be used to estimate channel characteristics and implement wireless techniques such as beamforming, a transmission method of focusing the transmission toward a receiving device. However, sounding can require multiple message exchanges and the performance computing operations by the devices present in the environment. A passive BKD may not be able to perform the multiple message exchanges and/or computing operations, may require different signals for performing sounding, and/or may need to switch between antenna states. Furthermore, uplink operations may be performed between a BKD and multiple Access Points (APs), so sounding can include evaluating the signals the BKD modulates and reflects. New mechanisms for performing sounding and beamforming may therefore be implemented when passive BKDs are present in the environment.

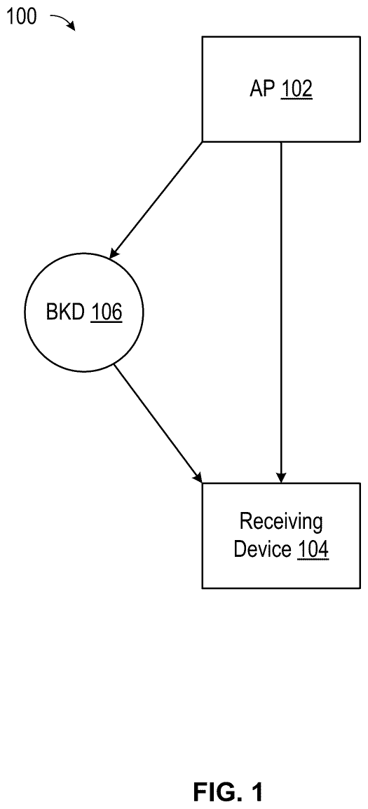

FIG. 1 is a block diagram of an operating environment 100 for passive Backscatter Device (BKD) sounding. The operating environment 100 includes an AP 102, a receiving device 104, and a BKD 106. The AP 102 may enable devices to access the wireless network. The receiving device 104 may be a device that accesses the network, such as a personal computer, a server, a tablet, a laptop, a smart phone, etc. In some embodiments, the receiving device 104 is another AP.

The BKD 106 can include components to receive a signal, modulate the signal to encode data, and reflect the modulated signal. For example, the BKD 106 can include one or more antennas to receive and/or transmit signals, a transceiver, an energy module to convert received signals into energy, logic for modulating (e.g., backscattering, amplitude shift keying) received signals, storage, sensors, and/or the like. The BKD 106 may be a passive BKD and therefore unable to transmit and/or receive every type of signal for the typical process of channel sounding.

For uplink sounding, the AP 102 can transmit an excitation signal to the BKD 106 and a sounding signal to the receiving device 104. The BKD 106 can modulate (e.g., amplitude shift keying using the impedance of one or more antennas) and reflect the excitation signal. The receiving device 104 receives the signal from the AP 102 and the reflected signal from the BKD 106. To perform this process for uplink sounding, interference must be managed between the sounding signal the AP 102 sends and the modulated and reflected signal the BKD 106 sends. In some embodiments, the AP 102 may maximize the power of the excitation signal or otherwise transmit the excitation signal at a higher power than the sounding signal to the receiving device 104, and the resulting modulated and reflected signal may have a maximized power or otherwise higher power than the sounding signal. The Signal-to-Interference-plus-Noise Ratio (SINR) of the modulated and reflected signal the BKD 106 sends to the receiving device 104 may therefore be maximized or otherwise at an acceptable level for use in the sounding process.

There may be additional devices in the operating environment 100 in further embodiments. For example, there may be additional APs 102, receiving devices 104, and/or BKDs 106. The sounding processes described below including the BKD 106 can thus include the AP 102 performing sounding processes with multiple receiving devices 104 and/or multiple BKDs 106 in some embodiments.

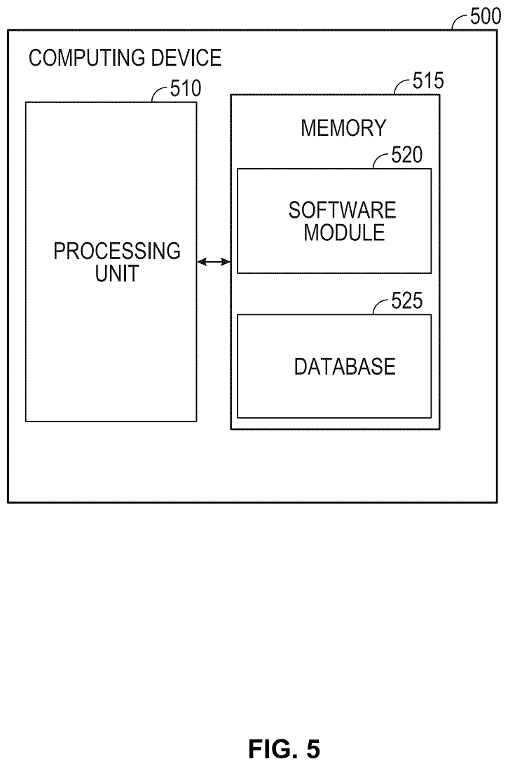

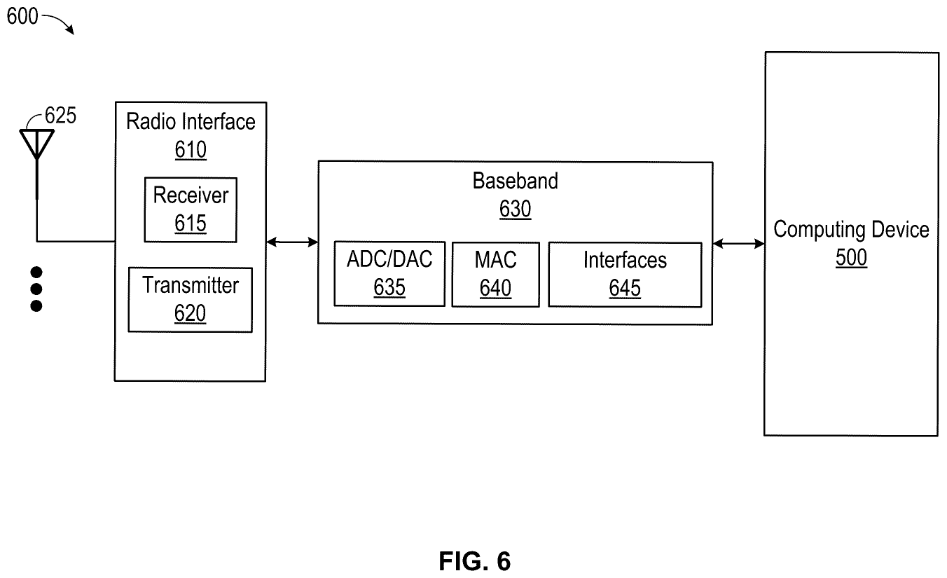

The elements described above of the operating environment 100 (e.g., the AP 102, the receiving device 104, the BKD 106, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 5 and 6, the elements of the operating environment 100 may be practiced in a computing device 500 and/or communications device 600.

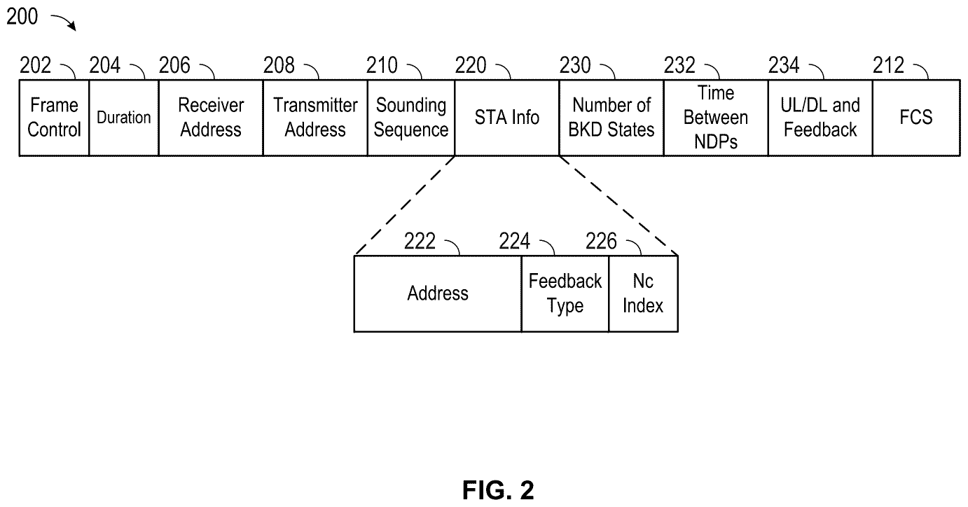

FIG. 2 is a block diagram of a Null Data Packet Announcement-BKD (NDPA-BKD) frame 200 in accordance with aspects of the present disclosure. A Null Data Packet Announcement (NDPA) is typically transmitted only for devices associated with a transmitting device (e.g., a client device that has performed the association process with the transmitting device). However, transmitting devices such as the AP 102 can send the NDPA-BKD frame 200 to both associated devices and unassociated devices. For example, to complete sounding with the receiving device 104, the AP 102 can trigger two or more sounding events with the receiving device 104 and the BKD 106 with the NDPA-BKD frame 200. The NDPA-BKD frame 200 announces multiple Null Data Packet (NDP) frames with the NDPA-BKD frame 200. For example, the NDPA-BKD frame 200 announces a sounding frame, such as an NDP frame, for each antenna state of a BKD utilized for the sounding process, such as the BKD 106.

The NDPA-BKD frame 200 may be similar to a typical NDPA frame and include a frame control field 202, a duration field 204, a receiver address field 206, a transmitter address field 208, a sounding sequence field 210, a Frame Check Sequence (FCS) field 212, one or more Station (STA) information fields 220. The frame control field 202 includes information about the NDPA-BKD frame 200, such as the type of frame, the data rate, the power management status, and/or the like. The duration field 204 specifies the length of time that the channel will be occupied by sounding, including the transmission of the NDPA-BKD frame 200, transmitting a NDP frame, and receiving responses from the recipients of the NDPA-BKD frame 200 and NDP as will be described in more detail herein.

The receiver address field 206 includes the recipient address (e.g., a Media Access Control (MAC) address) when the NDPA-BKD frame 200 includes a single STA information field 220 or a broadcast address when the NDPA-BKD frame 200 includes multiple STA information fields 220. For example, the receiver address field 206 may include the MAC address of the receiving device 104. The transmitter address field 208 includes the address of the device transmitting the NDPA-BKD frame 200. For example, the transmitter address field 208 may include the MAC address of the AP 102. The sounding sequence field 210 includes a sequence number associated with the current sounding sequence. The FCS field 212 includes an FCS, an error-detecting code that can be used to detect errors in a received NDPA-BKD frame 200.

Each STA information field 220 can be intended for a recipient to indicate the feedback requested for sounding and the desired structure of the feedback matrix (e.g., the number of columns in the feedback matrix). The STA information field 220 can include an address field 222, a feedback type field 224, and a Nc Index field 226. Instead of including at least a portion of an Association Identifier (AID) for indicating the intended recipient in the address field 222, the address field 222 may include the MAC address of the intended recipient (i.e., the device the respective STA information field 220 is intended to be sent to). For example, the address field 222 may include the MAC address of the receiving device 104. Thus, the NDPA-BKD frame 200 can be sent to associated devices and unassociated devices (that do not have an AID) because AIDs are not used to indicate the intended recipient device.

The feedback type field 224 indicates the requested feedback type, such as single user or multi-user. The Nc index field 226 indicates the feedback matrix dimension requested. Thus, the recipient device can respond with data for sounding according to the feedback requested and with the desired or otherwise correct feedback matrix structure.

The NDPA-BKD frame 200 also includes a BKD states field 230, a time between NDPs field 232, and an uplink, downlink, and feedback field 234. In some embodiments, the BKD states field 230, the time between NDPs field 232, and the uplink, downlink, and feedback field 234 are part of an additional control field. The BKD states field 230 indicates the number of BKD states to sound, for example based on the number of antennas the BKD has. For example, the BKD 106 may have multiple impedance states for each antenna (e.g., one or more reflecting states and a non-reflecting state), and the total number of BKD states may be determined based on the number of antennas the BKD 106 has. The BKD 106 may have multiple reflecting states per antenna by varying antenna impedance. If the number of states for the BKD 106 is not known, the default value may be two impedance states.

Because the BKD always has multiple antenna states and the AP 102 sends a NDP frame for each antenna state, the AP 102 announces the transmission of multiple NDP frames via the NDPA-BKD frame 200. The time between NDPs field 232 indicates the length of time between the transmission of the NDP frames or other sounding frames the AP 102 will use. The period between frames may be set to enable the BKD(s) to switch states and for the receiving device(s) to generate and send feedback to the transmitting device.

The uplink, downlink, and feedback field 234 indicates whether uplink sounding and/or downlink sounding should be performed and when the receiving devices should send the feedback. The uplink, downlink, and feedback field 234 can indicate to the receiving devices to send the feedback following the sounding frame in the same Transmit Opportunity (TXOP) (i.e., during the sounding process TXOP) or to send the feedback in a different TXOP. For example, when the uplink, downlink, and feedback field 234 is set to indicate that only uplink sounding should be performed with sounding of downlink and/or feedback steering. In another example, the uplink, downlink, and feedback field 234 is set to indicate to receiving devices to perform uplink sounding and downlink sounding and to send feedback following the sounding frame in the same TXOP. In yet another example, the uplink, downlink, and feedback field 234 is set to indicate to the receiving devices to perform uplink sounding and downlink sounding and to send feedback in a different TXOP.

As described above, the AP 102 can initiate two sounding events using the NDPA-BKD frame 200. The first sounding event may be with the BKD 106 set to a “off” impedance or low impedance state. For example, the BKD 106 may maintain the low impedance state used when modulating a signal to modulate a sounding signal and send the modulated sounding signal to the receiving device 104. The second sounding event may be with the BKD 106 set to the “on” impedance or high impedance state. For example, the BKD 106 may maintain the high impedance state used when modulating a signal to modulate a sounding signal and send the modulated sounding signal to the receiving device 104.

The BKD 106 can generate channel estimates and/or other feedback during the two sounding events, modulate the signal received from the AP 102 to encode the channel estimates and other feedback and transmit the modulated signal to the receiving device 104. The AP 102 can repeat sounding of these two states to filter out noise in some example implementations. In other embodiments with a different number of BKD states, the AP 102 may initiate the corresponding number of sounding events.

When the BKD 106 performs downlink sounding, the BKD 106 can estimate the channel for the received NDP or other sounding frame during uplink sounding. Using the uplink, downlink, and feedback field 234, the AP 102 can control when the BKD 106 feeds that downlink estimate via uplink.

The AP 102 can also schedule sounding to multiple devices in a single sounding event, and any BKDs involved in the sounding event can use the NDPA-BKD frame 200 to determine what state to be in at a particular time. For example, the BKDs can determine when to set the state to a high impedance state (e.g., an “on” state) and when to set the state to the low impedance state (e.g., “off” state). In some embodiments, multiple BKDs, such as passive BKDs, can be sounded simultaneously on different Orthogonal Frequency-Division Multiple Access (OFDMA) Resource Units (RUS).

The receiving device 104 can receive the channel estimates and/or other feedback for the two sounding events from the BKD 106. The receiving device 104 can use said feedback from the BKD 106 and the signals from the AP 102 to determine the feedback (e.g., the feedback matrix) and respond to the AP 102 with a compressed feedback frame. In some embodiments, the receiving device 104 can select at least a portion of the total Receive (RX) paths (e.g., an M amount of N RX paths) to suppress, disable, or ignore in the sounding to enable more degrees of freedom for the AP 102 to beamform and/or null steer in the system. For example, the AP 102 and the receiving device 104 have four Transmit (TX) and RX paths, and the feedback matrix is four columns and four rows for each subcarrier. The receiving device 104 can determine to ignore anything heard on RX path number four, thereby enabling the AP 102 to beamform to other devices using the RX path number four without interfering with the receiving device 104.

The receiving device 104 sends back the compressed steering for the different states of the BKD 106 (e.g., high impedance and low impedance states) to the AP 102. Thus, the AP 102 receives compressed feedback for all of the BKD 106 states and in this example for two states. In an example the feedback for both states is denoted V1,2, low and V1,2, high for the low impedance state and the high impedance state. The AP 102 can the determine the beamforming vectors to use when beamforming to the receiving device 104. An example selection of beamforming vectors to use to beamform to the receiving device 104 may be denoted as UDVbeamforming=(V1,2,low)H(V1,2,low)+(V1,2,high)H(V1,2,onhigh where H(V1,2,low) and H(V1,2,high) denote the feedback matrix of the corresponding state.

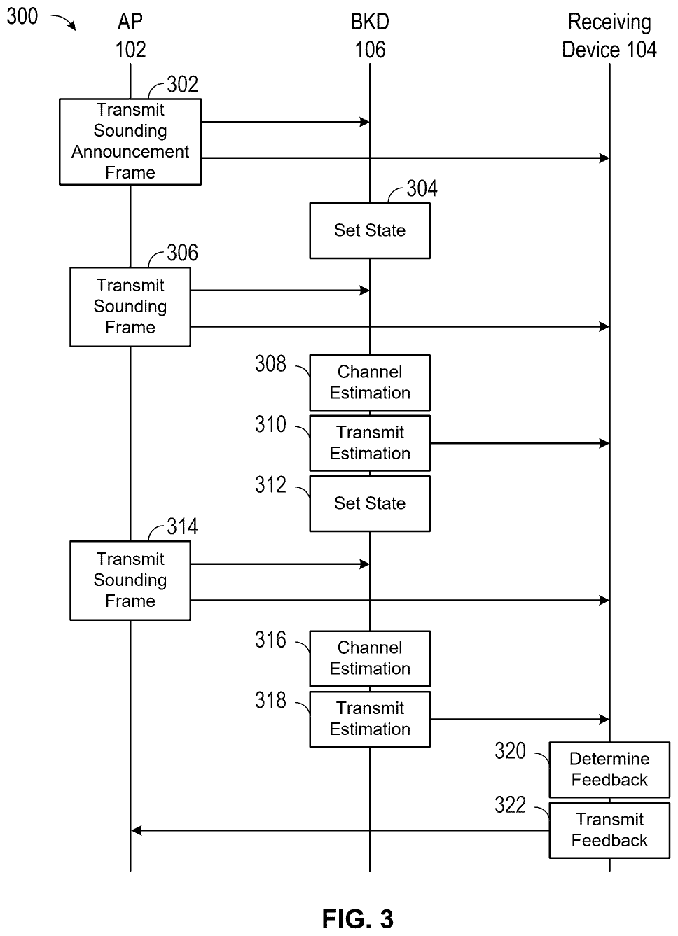

FIG. 3 is a signal diagram of a signal process 300 for passive BKD sounding in accordance with aspects of the present disclosure. The signal process 300 is shown between the AP 102, the receiving device 104, and the BKD 106 in this embodiment, but additional receiving devices 104 and/or BKDs 106 may be included in the signal process 300 in other examples. For example, the AP 102 may schedule sounding to multiple devices in a single sounding event.

The signal process 300 can begin when the AP 102 determines to perform channel sounding and transmits a sounding announcement frame in operation 302. In some embodiments, the sounding announcement frame is a NDPA-BKD frame 200. The BKD 106 and the receiving device 104 can use the NDPA-BKD frame 200 to determine the receiving device 104 as the intended recipient, determine the number of BKD states as two (indicated by the number of BKD states field 230), determine the time between sounding frames (indicated in the time between NDPs field 232), and determine whether uplink sounding and/or downlink sounding will be performed and when to send feedback (indicated in the uplink, downlink, and feedback field 234). Additionally, the receiving device 104 and/or the BKD 106 are not required to be associated with the AP 102 because the address field 222 will include a MAC address of the device instead of an AID.

The BKD 106 can determine its state for the first sounding event using the NDPA-BKD frame 200 received in operation 302. In operation 304, the BKD 106 sets its state for the first sounding event. Setting the state can include the BKD 106 determining the antenna to use and the state of the antenna. For example, the BKD 106 is set to the low impedance state. In some embodiments, the BKD 106 may already be set to the desired state when the BKD 106 receives the NDPA-BKD frame 200.

The AP 102 then transmits a sounding frame in operation 306. For example, the AP 102 transmits a NDP to the BKD 106 and the receiving device 104. The BKD 106 can perform channel estimation and/or generate other feedback during 308 and modulate the sounding frame to encode the information. In some embodiments, the BKD 106 performs the channel estimation by modulating the sounding frame via the respective state. The BKD 106 then transmits the modulated signal with the channel estimation to the receiving device 104 in operation 310. In some embodiments, the BKD 106 may not modulate and reflect the signal, so the BKD 106 may skip operations 308 and 310. In operation 312, the BKD 106 sets its state for the next sounding frame.

The AP 102 sends a second sounding frame in operation 314. For example, the AP 102 transmits a NDP to the BKD 106 and the receiving device 104. The BKD 106 again performs channel estimation and/or generates other feedback in operation 316 (e.g., modulating the sounding frame via the present impedance state) and transmits the channel estimation to the receiving device 104 in operation 318. In some embodiments, the BKD 106 may not modulate and reflect the signal, so the BKD 106 may skip operations 316 and 318. In operation 320, the receiving device 104 determines the feedback to be transmitted to the AP 102 to complete channel sounding. In some embodiments, the receiving device 104 may determine the feedback in two parts, such as after receiving the channel estimation and/or other feedback from the BKD 106 in operation 310 and after receiving the channel estimation and/or other feedback from the BKD 106 in operation 318.

The receiving device 104 transmits the feedback to the AP 102 in operation 322. In some embodiments, the receiving device 104 uses a compressed beamforming action frame to transmit the feedback. The receiving device 104 may transmit the feedback during the same TXOP as the channel sounding or in a later TXOP based on the NDPA-BKD frame 200. In some embodiments, the receiving device 104 transmits the feedback at two different times, such as such as after determining feedback in response to receiving the channel estimation and/or other feedback from the BKD 106 in operation 310 and after determining feedback in response to receiving the channel estimation and/or other feedback from the BKD 106 in operation 318.

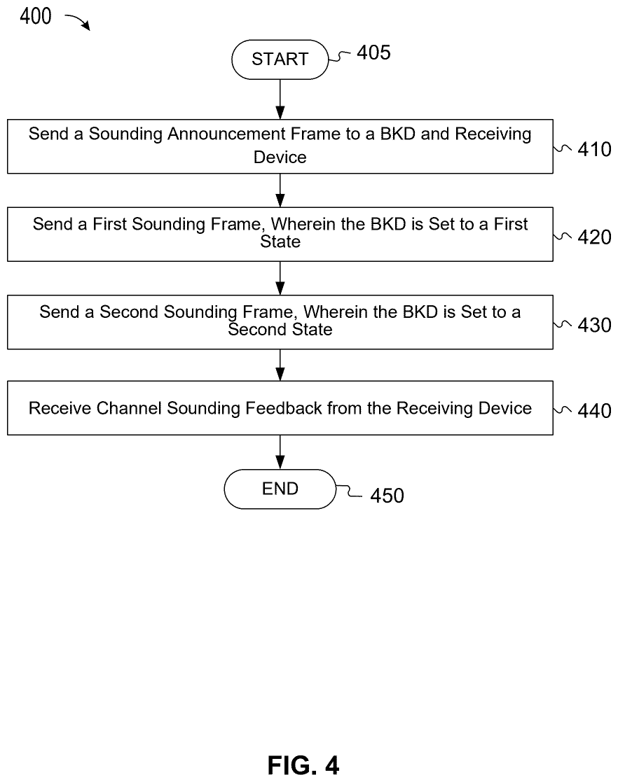

FIG. 4 is a flow chart of a method 400 for passive BKD sounding. The method 400 begins at starting block 405 and proceeds to operation 410. In operation 410, a sounding announcement frame is sent to a BKD and a receiving device. For example, the AP 102 sends a sounding announcement frame to the BKD 106 and the receiving device 104. The sounding announcement frame can announce a plurality of sounding frames for channel sounding over a plurality of antenna states of the BKD 106. The sounding frame is a NDPA-BKD frame 200 in certain embodiments. The sounding announcement frame can include a BKD states field 230 that indicates a number of BKD states to sound, a time between sounding frames field (e.g., a time between NDPs field 232) that indicates a length of time between sending sounding frames, an uplink, downlink, and feedback field 234 that indicates whether uplink sounding should be performed, whether downlink sounding should be performed, and when to send the channel sounding feedback, and/or the like. In some examples, the BKD states field 230, the time between sounding frames field (e.g., the time between NDPs field 232), and the uplink, downlink, and feedback field 234 may be parts of an additional control field.

In operation 420, a first sounding frame is sent to the BKD and the receiving device, wherein the BKD is set to a first state of the plurality of antenna states. For example, the AP 102 sends a first sounding frame (e.g., an NDP) to the BKD 106 and the receiving device 104. The BKD 106 may be set to a first state, such as a low impedance state. The BKD 106 can modulate the first sounding frame at the first state (or otherwise perform channel estimation) and send the modulated first sounding frame to the receiving device 104.

In operation 430, a second sounding frame is sent to the BKD and the receiving device, wherein the BKD is set to a second state of the plurality of antenna states. For example, the AP 102 sends a second sounding frame (e.g., an NDP) to the BKD 106 and the receiving device 104. The BKD 106 may be set to a second state, such as a high impedance state. The BKD 106 can modulate the second sounding frame at the second state (or otherwise perform channel estimation) and send the modulated second sounding frame to the receiving device 104.

In operation 440, channel sounding feedback is received from the from the receiving device. For example, the AP 102 receives the channel sounding feedback from the receiving device 104. The receiving device 104 can determine channel sounding feedback using the first sounding frame, the second sounding frame, the modulated first sounding frame, and the modulated second sounding frame and send the channel sounding feedback to the AP 102, such as via a compressed beamforming action frame. The AP 102 can determine beamforming vectors for beamforming to the receiving device 104 using the channel sounding feedback. The AP 102 can then perform beamforming when transmitting to the receiving device 104.

The AP 102 can also determine paths the receiving device 104 has selected to suppress, disable, or otherwise ignore. The AP 102 can also schedule channel sounding to one or more additional BKDs and/or one or more additional receiving devices. The BKD 106 and the one or more additional BKDs may be assigned or otherwise know state sequences for the sounding frames the AP 102 will transmit. The method 400 may conclude at ending block 450.

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for channel sounding with one or more passive BKDs with respect to FIG. 1, FIG. 2, FIG. 3, and FIG. 4. Computing device 500, for example, may provide an operating environment for the AP 102, the receiving device 104, the BKD 106, and the like. The AP 102, the receiving device 104, the BKD 106, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

FIG. 6 illustrates an implementation of a communications device 600 that may implement one or more of the AP 102, the receiving device 104, the BKD 106, etc., of FIGS. 1-4. In various implementations, the communications device 600 may comprise a logic circuit. The logic circuit may include physical circuits to perform operations described for one or more of the AP 102, the receiving device 104, the BKD 106, etc., of FIGS. 1-4, for example. As shown in FIG. 6, the communications device 600 may include one or more of, but is not limited to, a radio interface 610, baseband circuitry 630, and/or the computing device 500.

The communications device 600 may implement some or all of the structures and/or operations for AP 102, the receiving device 104, the BKD 106, etc., of FIGS. 1-4, storage medium, and logic circuit in a single computing entity, such as entirely within a single device. Alternatively, the communications device 600 may distribute portions of the structure and/or operations using a distributed system architecture, such as a client station server architecture, a peer-to-peer architecture, a master-slave architecture, etc.

A radio interface 610, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 610 may include, for example, a receiver 615 and/or a transmitter 620. The radio interface 610 may include bias controls, a crystal oscillator, and/or one or more antennas 625. In additional or alternative configurations, the radio interface 610 may use oscillators and/or one or more filters, as desired.

The baseband circuitry 630 may communicate with the radio interface 610 to process, receive, and/or transmit signals and may include, for example, an Analog-To-Digital Converter (ADC) for down converting received signals with a Digital-To-Analog Converter (DAC) 635 for up converting signals for transmission. Further, the baseband circuitry 630 may include a baseband or PHYsical layer (PHY) processing circuit for the PHY link layer processing of respective receive/transmit signals. Baseband circuitry 630 may include, for example, a MAC processing circuit 640 for MAC/data link layer processing. Baseband circuitry 630 may include a memory controller for communicating with MAC processing circuit 640 and/or a computing device 500, for example, via one or more interfaces 645.

In some configurations, PHY processing circuit may include a frame construction and/or detection module, in combination with additional circuitry such as a buffer memory, to construct and/or deconstruct communication frames. Alternatively or in addition, MAC processing circuit 640 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
sending a sounding announcement frame to a Backscatter Device (BKD) and a receiving device, wherein the sounding announcement frame announces a plurality of sounding frames for channel sounding over a plurality of antenna states of the BKD;
sending to the BKD and the receiving device a first sounding frame, wherein the BKD is set to a first state of the plurality of antenna states;
sending to the BKD and the receiving device a second sounding frame, wherein the BKD is set to a second state of the plurality of antenna states; and
receiving channel sounding feedback from the receiving device.

2. The method of claim 1, wherein:
the sounding announcement frame comprises a Null Data Packet Announcement (NDPA)-BKD frame; and
the plurality of sounding frames comprise Null Data Packet (NDP) frames.

3. The method of claim 1, wherein the sounding announcement frame further comprises any one of: (i) a BKD states field that indicates a number of BKD states to sound, (ii) a time between sounding frames field that indicates a length of time between sending sounding frames, (iii) an uplink, downlink, and feedback field that indicates whether uplink sounding should be performed, whether downlink sounding should be performed, and when to send the channel sounding feedback.

4. The method of claim 1, wherein the BKD is operable to:
modulate the first sounding frame at the first state;
modulate the second sounding frame at the second state; and
send the modulated first sounding frame and the modulated second sounding frame to the receiving device.

5. The method of claim 4, wherein the receiving device is operable to determine the channel sounding feedback using the first sounding frame, the second sounding frame, the modulated first sounding frame, and the modulated second sounding frame.

6. The method of claim 1, further comprising determining beamforming vectors based on the channel sounding feedback to beamform to the receiving device.

7. The method of claim 1, further comprising scheduling channel sounding to (i) one or more additional BKDs, (ii) one or more additional receiving devices, or (iii) both (i) and (ii), wherein the BKD and the additional BKDs are assigned state sequences.

8. A system comprising:
a memory storage; and
a processing unit coupled to the memory storage, wherein the processing unit is operative to:
send a sounding announcement frame to a Backscatter Device (BKD) and a receiving device, wherein the sounding announcement frame announces a plurality of sounding frames for channel sounding over a plurality of antenna states of the BKD;
send to the BKD and the receiving device a first sounding frame, wherein the BKD is set to a first state of the plurality of antenna states;
send to the BKD and the receiving device a second sounding frame, wherein the BKD is set to a second state of the plurality of antenna states; and
receive channel sounding feedback from the receiving device.

9. The system of claim 8, wherein:
the sounding announcement frame comprises a Null Data Packet Announcement (NDPA)-BKD frame; and
the plurality of sounding frames comprise Null Data Packet (NDP) frames.

10. The system of claim 8, wherein the sounding announcement frame further comprises any one of: (i) a BKD states field that indicates a number of BKD states to sound, (ii) a time between sounding frames field that indicates a length of time between sending sounding frames, (iii) an uplink, downlink, and feedback field that indicates whether uplink sounding should be performed, whether downlink sounding should be performed, and when to send the channel sounding feedback.

11. The system of claim 8, wherein the BKD is operable to:
modulate the first sounding frame at the first state;
modulate the second sounding frame at the second state; and
send the modulated first sounding frame and the modulated second sounding frame to the receiving device.

12. The system of claim 11, wherein the receiving device is operable to determine the channel sounding feedback using the first sounding frame, the second sounding frame, the modulated first sounding frame, and the modulated second sounding frame.

13. The system of claim 8, the processing unit being further operative to determine beamforming vectors based on the channel sounding feedback to beamform to the receiving device.

14. The system of claim 8, the processing unit being further operative to schedule channel sounding to (i) one or more additional BKDs, (ii) one or more additional receiving devices, or (iii) both (i) and (ii), wherein the BKD and the additional BKDs are assigned state sequences.

15. A non-transitory computer-readable medium that stores a set of instructions which when executed perform a method executed by the set of instructions comprising:
sending a sounding announcement frame to a Backscatter Device (BKD) and a receiving device, wherein the sounding announcement frame announces a plurality of sounding frames for channel sounding over a plurality of antenna states of the BKD;
sending to the BKD and the receiving device a first sounding frame, wherein the BKD is set to a first state of the plurality of antenna states;
sending to the BKD and the receiving device a second sounding frame, wherein the BKD is set to a second state of the plurality of antenna states; and
receiving channel sounding feedback from the receiving device.

16. The non-transitory computer-readable medium of claim 15, wherein:
the sounding announcement frame comprises a Null Data Packet Announcement (NDPA)-BKD frame; and
the plurality of sounding frames comprise Null Data Packet (NDP) frames.

17. The non-transitory computer-readable medium of claim 15, wherein the sounding announcement frame further comprises any one of: (i) a BKD states field that indicates a number of BKD states to sound, (ii) a time between sounding frames field that indicates a length of time between sending sounding frames, (iii) an uplink, downlink, and feedback field that indicates whether uplink sounding should be performed, whether downlink sounding should be performed, and when to send the channel sounding feedback.

18. The non-transitory computer-readable medium of claim 15, wherein the BKD is operable to:
modulate the first sounding frame at the first state;
modulate the second sounding frame at the second state; and
send the modulated first sounding frame and the modulated second sounding frame to the receiving device.

19. The non-transitory computer-readable medium of claim 18, wherein the receiving device is operable to determine the channel sounding feedback using the first sounding frame, the second sounding frame, the modulated first sounding frame, and the modulated second sounding frame.

20. The non-transitory computer-readable medium of claim 15, the method executed by the set of instructions further comprising determining beamforming vectors based on the channel sounding feedback to beamform to the receiving device.
